(19) United States
(12) Patent Application Publication
(10) Pub. No.: US 2011/0040610 A1
(43) Pub. Date: Feb. 17, 2011

(54) System and Methods for Ordering and Presenting Custom Electronic Advertisements

(76) Inventor: Susan Araiza-Boys, Redding, CA (US)

Correspondence Address: CENTRAL COAST PATENT AGENCY, INC, 3 HANGAR WAY SUITE D, WATSONVILLE, CA, 95076, US

(21) Appl. No.: 12/540,011

(22) Filed: Aug. 12, 2009

(51) Int. Cl. G06Q 30/00; G06Q 50/00

(52) U.S. Cl. 705/14.35; 705/14.42; 705/14.54; 705/14.56; 705/14.64

(57) ABSTRACT

A system for ordering electronic advertisements includes a first interactive interface executable to run on a computing appliance connected to a network for configuring constraints relative to an advertisement service, and a second interactive interface executable to run on the computing appliance for displaying electronic advertisements from one or more advertisement stores connected to the network and associated with the advertisement service. A user operating the computing appliance inputs into the first interactive interface the types of goods and services desired and what pricing associated with those goods and services is acceptable and wherein the second interactive interface displays advertisements served to the computing appliance over the network that fit the user's input criteria.

### BACKGROUND OF THE INVENTION

1. Field of the Invention

The present invention is in the field of electronic advertising and pertains particularly to methods and apparatus for presenting custom advertising to consumers over a network.

2. Discussion of the State of the Art

In the field of electronic advertising, advertisers create ads for goods and services and send those ads for placement in a variety of electronic venues. The well-known Internet network is the most prominent advertising venue. Online advertisements may appear in Web pages and may be static banner-type ads or dynamic advertisements that appear as pop-up windows, or floating windows. Typically a browser reading the Web page causes the advertisements to appear in dynamic ads whereas banner-type ads are static and always visible as part of the HTML script of the page.

Online advertisements target users who visit Web pages and perform data searches online. Methods for determines the types of advertisements to push to the interfaces of these users have been developed that incorporate some information about users indirectly such as browsing history, profile information, and types of data searches conducted by the users.

A general problem with advertising online, or anywhere for that matter, is that consumers desired goods and services at prices that they can afford or that they can negotiate with vendors. Conventional means of advertising to users electronically does not take into account any direct information from the user relative to what the user wants in the way of goods and services or what the user is, at the time, willing to pay for goods and services desired. Electronic surveys are used by some companies, including advertisers, to help develop demographics that are used to refine product marketing and ad creation. However such surveys are largely ignored by users and those that do fill out the surveys sometimes answer the questions erroneously, for the fun of it, making the data unreliable. Surveys are not often conducted in a timely fashion such that all of the data can be disseminated quickly and made useful for creating ads and setting pricing levels that are still relevant by the time advertisements are sent out.

If a system could be developed that could determine exactly what types of goods and services individual consumers want at any given moment and what price ranges those goods and services could be sold for, then significant increases in ad response ratios could be realized in electronic advertising.

Therefore, what is clearly needed is system and methods for presenting dynamic advertisements to users electronically based on direct and timely input from those users relative to what advertisements they want to see and the acceptable price ranges they would be willing to pay for those goods and services.

### SUMMARY OF THE INVENTION

A problem stated above is that consumers desire goods and services at prices that they can afford or can negotiate with vendors, but conventional means of advertising to users electronically does not take into account any information from the user relative to what the user wants or what the user is willing to pay for goods and services. Electronic advertising takes place over a network of computers and servers and advertisements are served into user interfaces such as inside a browser interface displaying a Web page. Most advertisements are banner advertisements that are static, but there are others that appear dynamically according to information compiled about the user but without the user's direct input.

The inventor therefore considered functional elements of an electronic advertising system looking for elements that exhibit dynamic characteristics that could potentially be harnessed to provide electronic advertising but in a manner that would not be limited to demographics, profile or online behavior.

Electronic advertising is driven by opportunity for ad placement to reach a large number of users or users that are qualified by some demographic that might have a higher probability of response to the advertisement over a random recipient. Servers, computing appliances, storage mediums containing advertisements, and analytic engines for discerning user demographics or online behaviors are typically part of such apparatus.

The present inventor realized in an inventive moment that if, at the point of service, electronic advertisements could be caused to display in an interactive interface based on direct input from a user relative to the type of advertisements desired and the pricing the user is willing to pay for the goods and services advertised, a significant uptick in positive ad response might result. The inventor therefore constructed a unique electronic advertising system for serving advertising to consumers that allowed consumers to order the advertising by inputting constraints to the system relative to the types of goods and services desired and the acceptable prices the consumers are willing to pay for those goods and services. A significant increase in service to response ration results with no impediment to consumer activity while online.

Accordingly, in one embodiment of the present invention, a system is provided for ordering electronic advertisements. The system includes a first interactive interface executable to run on a computing appliance connected to a network for configuring constraints relative to an advertisement service, and a second interactive interface executable to run on the computing appliance for displaying electronic advertisements from one or more advertisement stores connected to the network and associated with the advertisement service. A user operating the computing appliance inputs into the first interactive interface the types of goods and services desired and what pricing associated with those goods and services is acceptable and wherein the second interactive interface displays advertisements served to the computing appliance over the network that fit the user's input criteria.

In one embodiment the first interactive interface is a registration and configuration interface and the computing appliance is a desktop or a notebook computer. In a preferred embodiment the first and second interfaces comprise a toolbar application coupled by extension to a browser application running on the computing appliance. In one embodiment the computing appliance is a cellular telephone or a personal digital assistant. In one embodiment the computing appliance is connected to the Internet network directly or through an Internet-connected sub-network.

In one embodiment constraint configuration includes a list of specific retail businesses, Web-based businesses, and service organizations approved by the user for receiving advertisements from. In one embodiment constraint configuration includes a preference for one or more geographic indicators governing advertisement service. In one embodiment constraint configuration includes goods or service specific time limits for advertisements to display in the second interactive interface. In one embodiment constraint configuration includes goods and service specific pricing criteria that must be met before related advertisements may be displayed in the second interactive interface. In one embodiment retail businesses include local grocery outlets and stores. In one embodiment the system further includes an interactive control for prioritizing the way advertisements appear in the second interface.

According to one aspect of the present invention, in a system for ordering electronic advertisements including a first interactive interface executable to run on a computing appliance connected to a network for configuring constraints relative to an advertisement service, and a second interactive interface executable to run on the computing appliance for displaying electronic advertisements from one or more advertisement stores connected to the network and associated with the advertisement service, a method is provided for brokering advertisements including the steps (a) publishing user-specified criteria for receiving advertisements to potential advertisers, (b) searching potential advertisement stores for advertisements fitting the published criteria, (c) negotiating with the advertisers where necessary to meet criteria of users, (d) receiving one or more advertisements that fit the user-specified criteria, and (e) serving one or more approved advertisements to one or more user-operated computing appliances.

In one aspect of the method in step (a) user-specified criteria is aggregated and prices averaged per the criteria for goods and services available. In one aspect in step (b) advertisement stores include any searchable medium connected to the network. In one aspect of the method in step (c) negotiation includes price negotiation for goods or services and time period negotiation for honoring negotiated pricing. In another aspect of the method in step (b) a search engine is used to locate and identify advertisements that fit user criteria. In one aspect in step (a) user criteria is published to a pricing server and advertisers make pledges to honor accepted criteria and create or modify existing advertisements to validate the pledge.

According to another embodiment of the present invention an advertisement brokering system is provided including a server connected to a network the server including software for publishing information and software for searching data stores, a plurality of user-operated computing appliances connected to the network and accessible to the server, one or more data stores connected to the network and accessible to the server, the data stores containing advertisements from competing vendors, and a plurality of distributed instances of client applications one per computing appliance, the applications including at least two interactive interfaces, one for registration and configuration and one for displaying advertisements.

Registered users upload criteria through the client applications specifying the type of advertisements and the acceptable pricing information for desired goods and services to the server for both publishing the criteria to advertisers for acceptance and for use as search criteria in searching of the one or more data stores for acceptable advertisements, which are subsequently served to the client applications according to individual criterion.

In one embodiment the network is the Internet network and the computing appliances are a mix of desktop computers, laptop computers cellular telephones and personal digital assistants. In one embodiment advertisements for desired goods and services are located based on a search of advertisement stores using the criteria of individuals to return available advertisements to those individuals or using average values from the aggregated criteria of multiple users to locate advertisements relative to most popular goods and services at the average pricing range calculated among the users inputs.

### BRIEF DESCRIPTION OF THE DRAWING FIGURES

FIG. 1 is an architectural overview of an advertising network according to an embodiment of the present invention.

FIG. 2 is an exemplary screen shot of an advertising toolbar nested in a browser application according to an embodiment of the present invention.

FIG. 3 is an exemplary screen shot of a browser-based interactive registration and service configuration interface according to an embodiment of the present invention.

FIG. 4 is an exemplary screen shot of a rule table relative to specific products or services according to an embodiment of the present invention.

FIG. 5 is a process flow chart illustrating steps for setting up advertisement delivery according to an embodiment of the present invention.

FIG. 6 is a block diagram illustrating an advertisement broker system according to an embodiment of the present invention.

FIG. 7 is a process flow chart illustrating an advertisement brokering process according to an embodiment of the present invention.

### DETAILED DESCRIPTION

The inventor provides a unique advertising service that allows clients to publish their own personal criteria for advertised products and services to a third-party service that looks to fit or solicit advertising that meets the end user requirements. The present invention is described in enabling detail in the following examples, which may include more than one embodiment of the present invention.

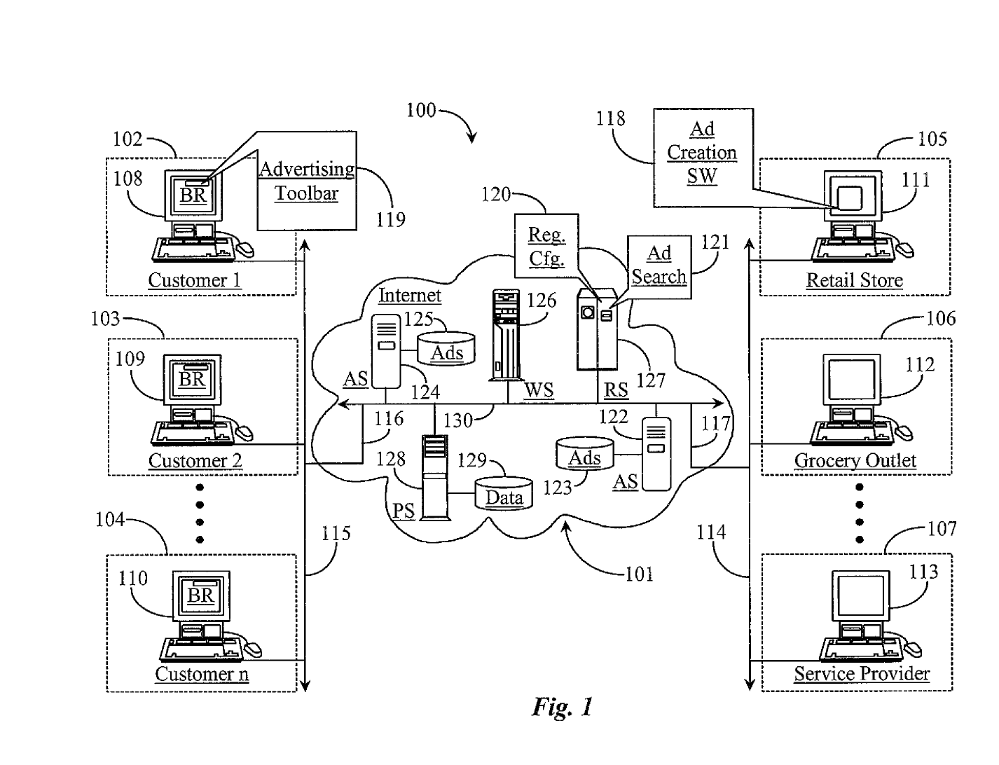

FIG. 1 is an architectural overview of an advertising network 100 according to an embodiment of the present invention. Advertising network 100 makes use of the Internet network 101 and any sub-networks connected thereto to carry electronic advertising to the end user. The advertising network is, in a preferred example, enabled by a third-party ad broker that maintains all of the equipment and software to fully practice the present invention. Although an advertising broker is not specifically illustrated in this example, equipment and SW illustrated in this example may be provided and maintained by such a broker.

Internet 101 includes a registration service 127 that may be accessible to potential clients through a Web page or other electronic interface. Service 127 is adapted to enable software download of a unique advertising toolbar 119 illustrated on a personal computer 108 of a customer 102 labeled customer 1. Advertising toolbar 119 enables at least one but preferably two interactive interfaces, one for enabling clients to configure ad presentation, and another for presenting advertisements according to configurations initiated by the client. Advertising toolbar 119 is an interface for ordering advertising and an interface for presenting the advertisements that fit the criteria of the order.

A plurality of customer locations is represented herein and includes a customer location 102, a customer location 103, and a customer location 104. These locations are further identified by a personal computer 108 at customer location 102, a personal computer 109 at customer location 103, and a personal computer 110 at customer location 104. The customers are further identified by labeling that denotes a customer 1, customer 2, and customer n to illustrate that there is no limit to the number of customers who may register for and practice the present invention to order advertising that they want to see. Each computer 108-110 is running an instance of a network browser (BR) application to which toolbar 119 is configured and installed as a downloadable toolbar application. A version of toolbar 119 may also be represented on computer 109 and computer 110 although none is illustrated.

The invention is not limited to practice by personal computers connected to the Internet. The invention may be practiced using any Internet-capable device meaning that the device connects to the Internet and navigates using a browser application. Customers 1-n represent any potential customers who want to see certain advertising that they have pre-approved by making their wants relative to advertising known to a third-party advertising system represented in this example by the equipment and software within Internet cloud 101.

Such as advertisement service may broker advertising between advertisers and customers like customers 1-n. Advertisers may be thought of as retail stores, grocery outlets and stores, or service providing entities. These are represented in this example by a retail store 105, a grocery outlet 106 and a service provider 113. Such advertisers have an online presence and advertise electronically as well as at physical store fronts and other locations. Electronic ads may comprise printable advertisements that may be taken into the location of the advertiser and presented for discount or other commodity. Ads may include any Web-based electronic advertisements that can be served from an advertising server.

A service provider may incorporate one or more advertisement servers illustrated herein as an advertisement server (AS) 124 and an advertisement server 122. Advertisement servers 124 and 122 each have a digital medium associated therewith that is adapted to store software, and data required for enabling server function. AS 124 has an accessible repository 125 adapted to store electronic advertisements for service to end users. AS 122 has an accessible repository 123 adapted to store electronic advertisements for service to end users. A registration server (RS) 127 is provided in this example and represents an interface through which any potential customers may register for the service of the present invention. RS 127 has a digital medium associated thereto which is adapted to store the data and software required to enable normal server function.

In this example, a registration and configuration (Reg. Cfg.) application is provided to enable customers like customers 1-n to register for service and to configure a download of a toolbar application (119) that fits their personal computing device, platform, and browser type. Advertising toolbar 119 is acquired after a customer registers and configures the download. In another embodiment, potential customers may acquire the advertising toolbar of the present invention by other methods and may install it to their browser applications but cannot activate the application until they register for service. The service of the invention may be offered alone or as a part of some larger service contract.

Customers 1-n are presumed to be registered subscribers to the service of the invention and each have an advertising toolbar such as toolbar 119 installed as a plug-in to their browsers. Toolbar 119 may also be installed to any other application that can access the Internet and receive data while online. In one embodiment of the invention, advertising toolbar receives all of the advertising sent electronically to a user with the acceptation of static banner ads or other Web-based ads that are not affected by the present invention. The toolbar may be configured in one embodiment to filter unsolicited popup ads or any other advertisements that were not ordered by the end user.

In order to deliver advertising to users that have specific criteria for doing business with select advertisers, the advertisers have to be flexible in their electronic advertising campaigns. In one embodiment, the service of the present invention includes a proprietary ad-creation software (SW) 118 illustrated on a personal computer 111 in retail store 105. SW 118 may be tailored to enable an advertiser to very quickly update an advertisement such as changing current pricing, available quantities, purchase time limits, quantity discounts, and other special aspects of an advertisement. In this way advertisers are given ample opportunity to re-design or tailor advertising to fit what the customers want in the way of pricing, service, and other aspects of doing business.

It is presumed in this example that businesses 105-107 are subscribers to or partners to the service of the present invention, which may be provided by a third-party service provider as described further above. Likewise, personal computers are no a requirement to practice the present invention. The invention may be practiced using any Internet capable appliance like a cellular telephone, personal digital assistant, notebook computer, or other Internet-capable appliance types. Internet 101 is further represented herein by an Internet backbone 130. Internet backbone 130 includes all of the equipment, lines, and access points that make up the Internet network as a whole. Therefore there is no geographic limitation to practicing the present invention.

Customers 1-n have Internet connectivity through Internet access network 115 and Internet access line 116. This is a logical representation as customers may have a wide variety of ways to connect to the Internet including but not limited to dial-up, digital subscriber line (DSL), broadband, cable/modem, wireless access, and so on. On the business side, businesses 105-107 have Internet connectivity via Internet access network 114 and Internet access line 117. Internet 101 includes a Web server (WS) 126 that is adapted to serve electronic information pages or Web pages to anyone connecting to the server and authorized to receive them. WS 126 has a digital medium associated thereto that contains software and data required to enable server function. WS 126 represents any server that serves Web pages including ecommerce pages hosted by advertisers like businesses 105-107.

In one embodiment the service of the present invention enables searching for electronic advertisements from any advertising source using an ad search application 121. Ad search application 121 may enable a third-party data search for advertising that may fit customer trends or requirements or may fit customer trends or requirements with some price or service modification made by the advertiser. In this way the service provider of the present invention may look for and add new product and service sources to the advertising network.

In one embodiment of the present invention a pricing server (PS) 128 is provided and connected to backbone 1230. PS 128 may be adapted to determine man, hi, and low-range pricing for products and services desired by customers. PS 128 has a digital medium associated thereto that is adapted to store all of the data and SW required for enabling server function. PS 128 has connection to a data repository 129 adapted to contain pricing information gathered from advertisements and other published information. In one embodiment, customers may consult pricing server 128 in order to gauge what a reasonable pricing might be for a product or service that they would like to see advertised in their advertising toolbar.

To practice the invention, customers like customers 1-n connect online to a server adapted for the purpose of registering the customers as subscribers to the service of the invention and after some information exchange and configuration they download and install advertising toolbar 119. After downloading and installing toolbar 119 a customer may configure the service of the invention, which broadly is to serve advertisements for presentation in the toolbar based on what that customer actually orders or wants to see based on the information input by the customer through the interface. The ad service provider armed with the customer information solicits advertising from businesses like retail store 105, grocery outlet 106 and service provider 107 for advertising that meets the customer's demands. Those solicited advertisements are then served to the customer through the advertising toolbar where they may be interacted with by the customer.

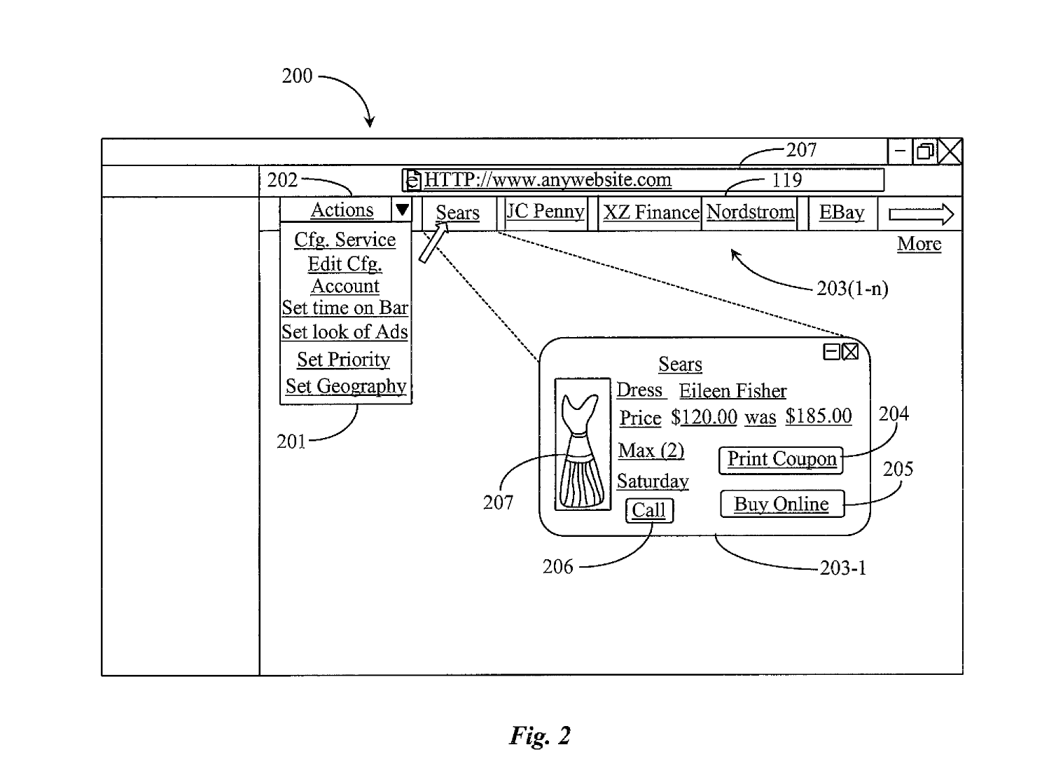

FIG. 2 is an exemplary screen shot of advertising toolbar 119 of FIG. 1 nested in a browser application according to an embodiment of the present invention. Advertising toolbar 119 is illustrated nested within browser application 200. Browser 200 has a typical navigation bar 207. Other typical features of a browser are not illustrated in this example because they have no relevance to the present invention. Toolbar 119 has a thumbnail presentation bar that contains advertisements 203 (1-n) that, in this example, visually represent each of the advertisers instead of their advertised products or services. In another embodiment advertisements 203 (1-n) may visually represent actual products and services sought by the customer rather than just the advertiser. In another embodiment advertisements 203 (1-n) may include audio features in their presentation.

A customer may interact with any of ads 203 (1-n) by mouse over or click to expand an advertisement into its own window. In this example the customer has interacted with the ad 203-1 from Sears™. The expanded ad 203-1 can be retracted or closed back into the toolbar. The ad shows a dress 207 from the dress maker Eileen Fischer that the customer wanted to see an advertisement on. In this case interacting with the Sears thumbnail produced a single advertisement. However, if the customer wants to view by advertiser then each thumbnail appearing may include one or more advertisements from that advertiser.

In this example the dress was marked down from $185.00 to $120.00, which fit the customer criteria causing delivery of the advertisement into toolbar 119. The advertiser (Sears™) has crafted the ad in the form of a printable coupon allowing the customer to print the coupon by interacting with a button 204 labeled print coupon. An option in the ad for buying online is presented in the form of a hyperlink 205, which takes the customer to the order page of Sears™. A hyperlink 206 is provided that allows the customer to call into Sears™ to purchase the dress over the telephone.

In exchange for dropping the price of dress 207 in order to meet the customer price range to obtain a potential sale, the advertiser enforces certain restrictions on the offer. For example, the deal is only good on Saturday and the maximum number of dresses that can be sold to a customer at the dropped price is 2 dresses. In this case the advertising service convinced Sears™ to lower the price. It is possible that a large number of customers subscribing to the service of the present invention would desire the dress at the offered price. If so, the ad service can provide a statistical or real number of such customers to the advertiser as further enticement to lower the price, at least temporarily.

Toolbar 119 is loaded, in this example, with ads from the advertisers Sears™, JC Penny™, XZ Finance, Nordstrom™, and eBay™. Toolbar 119 has a scrolling arrow that the customer may interact with to show more ads. In one embodiment the customer may specify that the ads presented in toolbar 199 are rotated through the whole list so that the customer may see all of the thumbnails without manually scrolling. In this case, if there are more than one ad associated with the thumbnail Sears™, then the other ads may appear collapsed in a list next to the first ad expanded in display enabling the customer to select an view all of the ads one at a time. In another embodiment the customer may expand all of the ads associated with the thumbnail simultaneously in the same or separate windows. In another embodiment ads may be presented individually within toolbar 119 such that each single ad has a thumbnail.

Toolbar 119 has an actions interface 202 that provides a drop down list 201 of interactive configuration options to the customer. Among the options in list 201 are configuring (Cfg.) ad service, editing the configuration, and managing the account or accounts (if the toolbar is shared). Each of these options, if selected, cause associated interactive windows to appear so the customer may continue to perform desired tasks.

Among other options available within the dropdown list 201 of actions interface 202 are toolbar configuration options for setting a time limit for an advertisement to be presented in the toolbar. Setting a time for ad display may be done according to advertiser such as “run ads from Sears for one week”. Setting a time for ad display may be configured according to product categories, or specific products or services regardless of the advertiser associated with the ads.

A customer may configure the look of ads presented within the toolbar. For example, toolbar 119 is loaded with thumbnails reflecting the look and feel of the advertisers and the customer may mouse over or click on one of the thumbnails to see one or more ads from that advertiser. In one embodiment the customer may expand the entire toolbar from its nested position and see all of the advertisements associated under the appropriate advertisers in a list or details view, an icon view, or as a thumbnail view. In one embodiment the customer may assign avatars or characters to certain products and services that the customer wants to see advertised in toolbar 119. In this case when an advertisement is selected for service into toolbar 119 the look of the thumbnail is that of the character or avatar the customer assigned to that product or service advertised in the ad. The characters may be supplied by the customer, the service provider or a mix of both.

A further option in drop down list 201 is setting the priority of ads presented within toolbar 119. This may also apply to advertisers where the thumbnails reflect advertisers instead of single ads. The priority scheme may be simple such as selecting which categories of products and services advertised in the toolbar should appear first in line in the toolbar. For example, the customer may set the category sporting goods as the highest priority resulting in the first few or more ads in the toolbar being ads for sporting goods. The second highest priority ads would appear next in line and so on. For a case where the thumbnails reflect advertisers having ads in the toolbar, priority can be based on the most preferred advertiser. Sears™ may be the highest priority advertiser while JC penny™ is the next highest and so on. If a preferred advertiser does not have any ads to serve, then the advertiser would not appear in the toolbar until one or more ads meeting criteria of the customer are available for service.

Dropdown list 201 includes an option for setting the geographic limits for ad sources. In this option the customer may specify a geographic constraint per product category, or per advertiser, or for all presented ads. The geographic constraint options may include local ads for products and services unique to my city, regional ads for products and services unique to my state or region, national advertisements for products and services available nationally, and international advertisements for products and services available on an international basis.

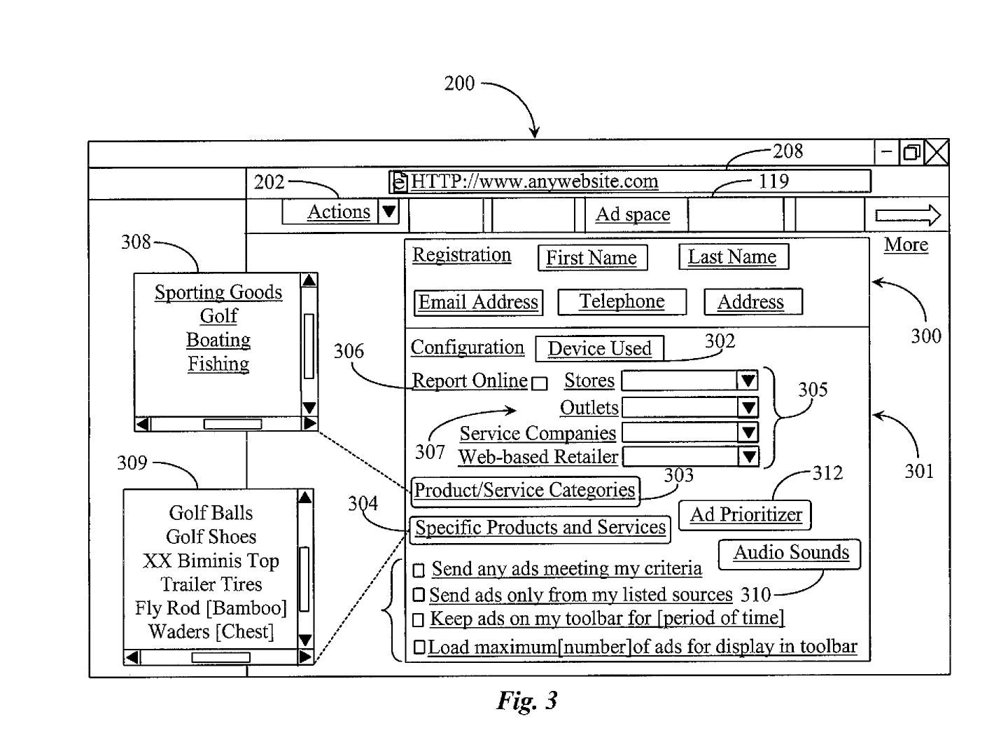

FIG. 3 is an exemplary screen shot of a browser-based interactive registration and service configuration interface according to an embodiment of the present invention. In this example toolbar 119 is nested within browser 200 but has not been activated. By interacting with actions 202 the customer may select service registration and service configuration option to register with the service as a subscriber and to configure the rest of the service relative to what the customer wants in the way of advertising. In another embodiment the customer may navigate to a Web page and may register for the service before downloading the toolbar of the present invention and then after obtaining the toolbar, may configure the rest of the service options.

In this example a registration information window 300 is presented for the customer to interact with. In this case the customer may activate text fields for submitting required information. The text fields illustrated in this example include a field for entering a first name, a field for entering a last name, a field for entering an email address, a field for entering a telephone number, and a field for entering a physical address. Other fields may be provided without departing from the present invention such as a field for entering a credit card number or other payment account information. A button for submitting the information to the service entity may be presumed in this example although it is not specifically illustrated. In one embodiment the service of the invention may be provided free to users whereas the service provider may take a percentage of the advertiser revenue enabled by the system.

In one embodiment a configuration information window 301 is displayed as a result of selection of a service configuration action in menu 202. A customer may optionally enter information about the computing device or appliance that will be used to display and interact with advertisements. For example the customer may want to activate the toolbar for a PC and for a cellular telephone. This may require that another toolbar designed for a cellular platform be downloaded and installed to a cell phone browser application.

In one embodiment the customer may select an option 306 for allowing the customer preferences to be reported online to a data mining server that aggregates data from as many customers as allowed and develops statistics about the group preferences such as most popular services and products, and the average price ranges the group will pay for those products and services. After purchase statistics can also be compiled by the advertising service provider such as the average price paid for a product or service, the most purchased products and services, the most preferred advertiser, and so on.

An advertising source information option 307 is presented in the form of a plurality of dropdown menus 305 wherein the customer may select which stores, outlets, service companies, and Web-based retailers that they want to see ads from. The resulting list may be thought of as the customer's favorite sources for products and services. An option 303 allows the customer to select desired product and service categories that they wish to see ads about. Interacting with option 303 may bring up an interactive window 308 where the customer may select options from a list of categories or may define and input their own categories of products and services. In this case the customer categories are sporting goods, golf, boating, and fishing. So the customer desires to see ads about products and services related to the categories sporting goods, golf, boating and fishing. Advertisements not related to these categories will not be served into toolbar 119.

An interactive option 304 enables the customer to list specific products and services under the categories permitted that the customer wants to see ads about. Interacting with option 304 brings up a window 309 in which the customer may select from a list of specific product or services that would be available under the listed categories. In one embodiment the customer may build their own list of specific products and services from scratch by entering the information. In this case the specific products listed are golf balls, golf shoes (category golf), XX Biminis top, trailer tires (category boating), bamboo fly rod, and chest waders (category fishing. These products take priority over other products advertised that fall under the categories listed because the customer has specified them. This means that the customer would likely purchase the listed items before any other items advertised.

An interactive option 312 for prioritizing how ads are displayed in the toolbar 119 is provided, which may be analogous to the option provided in dropdown menu 201 of FIG. 2. In one embodiment a customer may select an option 310 for configuring or selecting audio sounds for alerting the customer when an item of interest displays in toolbar 119. For example, if the customer wanted to see an advertisement for heels (under $40.00), an audio sound of heels clicking across a wood floor might be selected to notify the customer that such an advertisement has been served to the toolbar. Perhaps the customer is always looking for a specific brand of dog food when it is being sold for $15.00 or under for a 20 pound bag. When an ad meeting the criteria is served the customer may hear barking of a dog. In one embodiment the customer may simply select an option that orders sound alerts to be played for ads served about specified products and services wherein the service provides and selects the audio sound alerts.

Further options displayed in window 301 include radio buttons that may be checked to include certain general rules such as sending any advertisements meeting the customer criteria regardless of the advertiser. Another general rule might be sending only advertisements from the sources listed by the customer. Another general rule might be to keep ads in the toolbar for a specified period of time. The customer may reserve the right to delete ads from the toolbar so that an ad will remain there indefinitely if not deleted by the customer. Time based advertisements may be exempt such that they automatically disappear if they expire. Another general option may be to specify how many ads that can be loaded into the toolbar at any one time. For example, the customer may want to see only the top 10 qualifying advertisements. Another customer may specify a maximum number of loaded ads of 50 or more. The service may hold a minimum number of advertisements to be loaded to ensure customer participation. The more ad space the toolbar holds the less valuable the space is to a particular advertiser. The service provider may exert a limit to the number of ads that may exist in the toolbar at any given time. In one embodiment all of the configuration options described thus far are available through the toolbar action interface 202. The second interface available through the toolbar is the ads display interface.

Depending on the configuration, the user may see single ads or advertisers having ads served into the toolbar. In addition to specific audio alerts that may be associated with any ads meeting customer criteria, the customer may specify a visual alert such as a blinking thumbnail representing a new advertisement that has been loaded into the toolbar. Further, the customer may specify that text popup windows be used to alert the customer by text when the toolbar contains fresh ads.

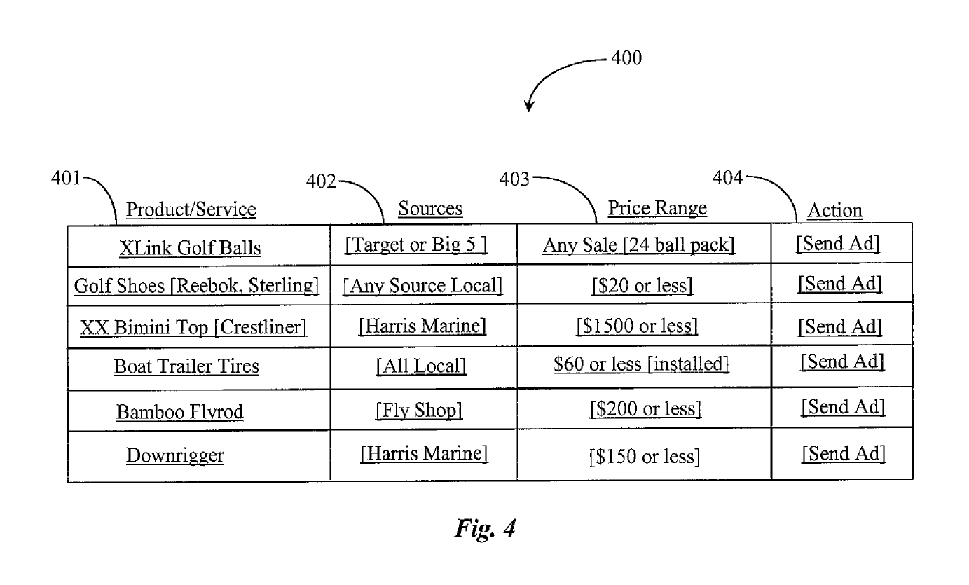

FIG. 4 is an exemplary screen shot of a rule table relative to specific products or services according to an embodiment of the present invention. A rule table 400 is illustrated in this example and logically represents constraints that a customer may place on ads about specified products and services. Table 400 has a column 401 in which the customer may specify products and services. Table 400 has a column 402 in which the customer may specify acceptable sources for the products and services listed in column 401. Table 400 has a column 403 in which the customer has specified acceptable pricing for the products and services listed in column 401. Table 400 includes a column 404 in which the customer specifies an action to be performed dependant on the constraints being true.

In the first row column 401 the customer specifies XLink golf balls as a product the customer wants to see advertising about. In the first row in column 402 the customer puts a constraint on the service of an advertisement for XLink golf balls by listing only two sources that the customer is willing to buy them from. In the first row column 403 the customer specifies a 24-ball pack at any sale price as a condition for service of an advertisement for XLink golf balls. Therefore if a 24-ball pack of XLink golf balls can be provided by Target™ or by Big 5™ at any sale price (condition-on sale), then the customer wants to see it advertised in the advertising toolbar. If an electronic ad for the golf balls does not exist, either or both companies may create a quick dynamic advertisement that can be served to the advertising toolbar of customer. In one embodiment if no electronic ads exist for service, the service provider may elect to build and serve an ad based on relevant information provided by the listed sources.

In the second row the customer wants to see advertising for golf shoes of the type Reebok™ or of the type Sterling™ from any local source (column 402, geographic constraint), at a price of $20.00 or below for the pair. Presumably if an ad meeting the criteria of the customer were served to the customer's advertising toolbar, the customer would interact with the ad and purchase the golf shoes, perhaps by printing the offer and taking it into the local store. However, service of the ad is not a guarantee to the advertiser that the customer will buy the product or service. But the chances that a purchase will occur are much greater than normal because the ad meets the customers stated goals for buying the product. If the service provider found during data mining that 300 customers have the golf shoes specified and would buy them at $20.00 or under, then any advertiser might gladly reduce the price temporarily to pick up 300 sales. The customer might be restricted in one embodiment to specifying price averages or ranges or pricing increments allowed by the service. Thus more normalization might be afforded the pricing constraint option.

In the third row column 401 the product is an XX Biminis top for a Crestliner™ pontoon. The customer only wants to see an ad from one source Harris Marine, and the acceptable price is $1500.00 or less. The customer is virtually monitoring Harris Marine using the service waiting for the Biminis to go on sale at $1500.00 or less. It is noted herein that if the service cannot find the Biminis top for sale at the shop then the service might publish the customer criteria for purchasing the top to the source, in this case Harris Marine. The dealer might create an ad/offer that meets the customer criteria for a one day sale for that customer. However, if a number of customers are looking for the same Biminis tops at $1500.00 or less the dealer might just come down to that price to profit from the number of tops that could be quickly sold.

The fourth row first column specifies boat trailer tires from any source (column 402) at $60.00 or less with an added constraint that they must be installed by the dealer. The rest of the items listed in table 400 follow the same process of identification of acceptable sources, specifying the price range and confirming the appropriate action, in this case, [send ad]. Other options might be negotiated when the customer interacts with an advertisement or a created offer that functions as an electronic advertisement such as color, size, etc. Advertisers may be afforded the option of applying one or more constraints on purchase of advertised products and services advertised to the customer. The advertiser may enforce certain restrictions in exchange for meeting the customers' stated criteria for buying the products and services. However, such restrictions may not conflict with customer criteria for receiving an advertisement.

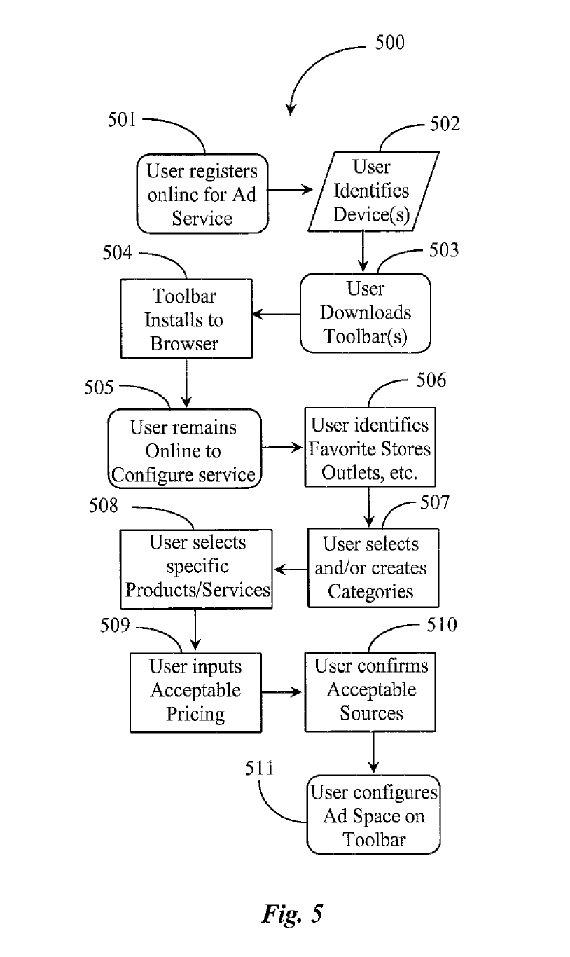

FIG. 5 is a process flow chart illustrating steps 500 for setting up advertisement delivery according to an embodiment of the present invention. At step 501 the user or potential customer registers online for advertising service at a Web site provided for the purpose. The service may be provided by an advertisement broker company that solicits advertising from advertisers based on customer demands and serves those ads that qualify into a unique advertising toolbar.

At step 502 the user identifies the computing devices and platforms that will support the advertising toolbar of the present invention. At step 503 the user downloads the advertising toolbar to the device or devices the user plans to receive advertising on. The advertising toolbar automatically extracts and installs to the user's browser at step 504. At step 505 the user may remain online for the purpose of configuring the advertising service. Configuration may entail several steps and sub-steps. At step 506 the user may optionally identify favorite stores, outlets, and other businesses that are to be advertising sources acceptable to the user. If step 506 is undertaken then no advertiser that is not on the user list will be allowed to send advertisements to that user.

The user may create product and service categories or select product and service categories from a list provided by the service provider at step 507. The categories selected or created are categories of products and. or services for which the user desires to see advertisements about. If the user configures categories advertisements that do not fit in the categories created or selected may not be served to the user. Advertisements for products and services that fall under any of the created or selected categories may be served provided there are no additional constraints placed by the user that would disqualify them from being served.

The user may add specific products and service descriptions under each category selected or created at step 508. In one embodiment all advertisements that fall within the confines of a category might still be served but ads for products and services specified in step 508 may be prioritized over those not specifically listed by the user. In one embodiment the user may restrict all advertising to just the specific products and services listed by the user.

The user may input acceptable pricing at step 509 for each specified product or service listed at step 508 so that only advertisements for those products and services that are within the user's acceptable price range may be served. At step 510 the user may confirm which sources (advertisers) are acceptable for the specified products and services. At his point the service knows what types of advertisements the user wants to see and under what conditions the user will accept service of those ads into the advertising toolbar. At step 511 the user may configure the ad spaces on the advertising toolbar relative to look and feel and priority of ads or advertisers displayed within the toolbar. Also in this step the user may configure ad geography, maximum ad number loaded into the toolbar, and time for ads to be displayed in the toolbar.

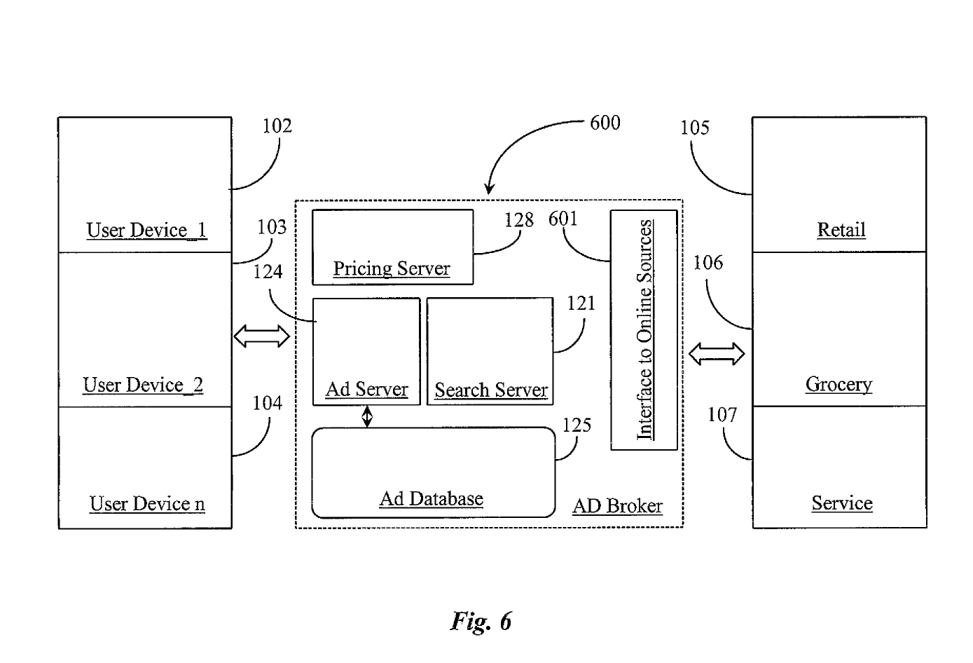

FIG. 6 is a block diagram illustrating an advertisement broker system 600 according to an embodiment of the present invention. Broker system 600 includes ad server 124 and connected ads database 125 as described with respect to FIG. 1. Search server 121 and pricing server 128 are also illustrated in this example. A registration server or interface may be presumed present in this example though none is illustrated.

After registration and configuration users now defined as potential customers or simply customers are connected to the ad server while online for advertising services. For example a customer may receive advertising into the advertising toolbar while performing simple or mundane online tasks such as downloading email, messaging, Web browsing, paying bills, etc. The advertising toolbar may receive advertising from advertisement server 124 whenever the customer is online. In this example customers 102-104, also referred to herein as devices (1-n) are online and ready to receive advertising from advertisement server 124.

Broker 600 has an interface 601 to online sources for advertising including Web-based businesses and organizations not to limit to retail stores 105, grocery stores 106 and service organizations 107. Pre-armed with mined knowledge of what the customer demands in the way of goods and services are at the present time, the advertising broker makes frequent contact with retail, grocery, and service companies among any other business that sells goods and/or services. These businesses are presented with data supporting certain statistics about what types of products and services these customers are actually looking for and at what prices they would be willing to accept. New advertisements may be created for service to customers the new ads complying with customer demands for viewing the advertisement.

Retail chains and other participating companies may be required to build their own advertising using a template provided by the service provider. The template referenced may be a part of ad creation software 118. Armed with statistics relative to what customers are looking for and, moreover, what their willing to pay, the participating companies 105-106 may create their own advertising in the form of electronic advertising for service into customer toolbars by ad server 124. Ads created by the companies may be stored for service after approval in ad database 125. Older advertisements not used or obsolete may be routinely purged from the database. On use for pricing server 128 might be to develop pricing stats for most popular products and services so that customers can give out realistic pricing demands for advertisements rather than asking for discounts that do not make economic sense to the advertiser.

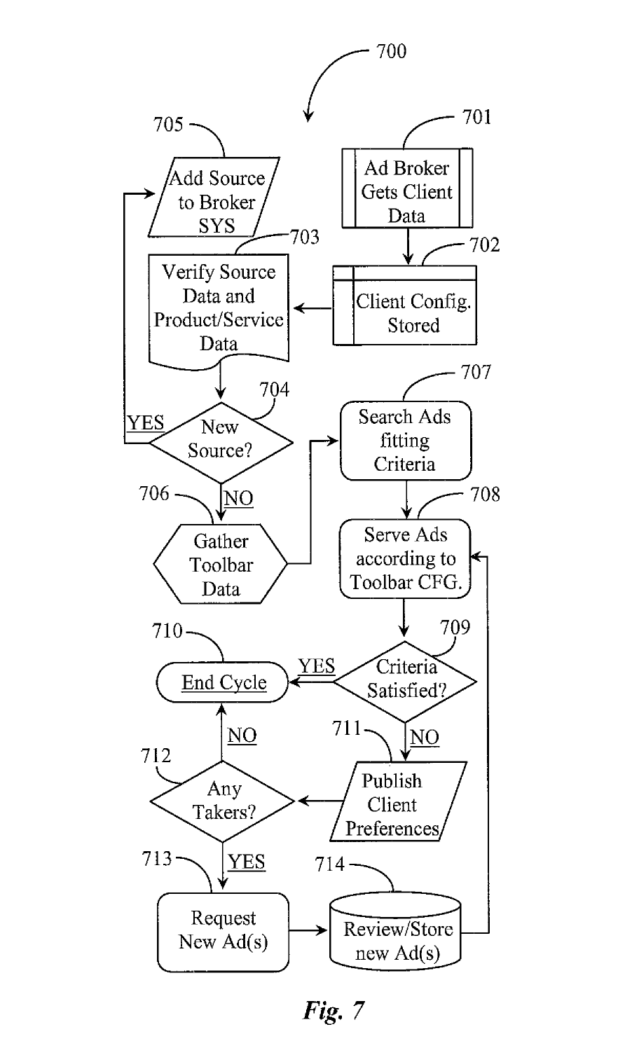

FIG. 7 is a process flow chart illustrating an advertisement brokering process according to an embodiment of the present invention. At step 701 the advertising broker gets data from the clients or customers through their individual toolbar configurations. At step 702 the advertising broker stores the data for reference. At step 703 the ad broker may verify the sources listed by customers and the product and service data listed by the customers. The service keeps records on all reported sources (advertisers). For example if a customer has a conflicting account of source and product, the service would alert the customer to the error. One example would be product=computer paper and source=ABC clothing. ABC clothing does not sell paper. The service makes attempts to validate all of the product source relationships.

At step 704 the service may identify any new sources that are reported by a customer. If a new source is reported in configuration data at step 704, the service may add the source to the list of participating sources at step 705 and may contact the source to solicit participation of the source. The service may contract with the source for a percentage of ad revenue supplied to the source through the service.

If no new source is reported at step 704 then the process moves to servicing customers at step 706 wherein the service gathers toolbar data from the customers to use to match advertising to customers based on customer demands. At step 707 the service may search for existing advertising that already fits the customer's criteria. Finding those advertisements, the service serves those advertisements to customer toolbars according to the customer configuration. If the customer criteria for any toolbar are satisfied, that is to say that ads meeting all of the customer's requirements were served for all specified products and sources, the cycle may end temporarily for that customer at step 710. However if the customer changed or edits configuration sources product categories, or products then the process may begin again for that customer culminating back at step 709.

If at step 709 the criteria of the customer are not yet satisfied, it may mean that there is a customer demand for which no existing advertisements can satisfy in current form. In this case at step 710 the service may publish customer criteria at step 711 to specified sources to solicit participation from any of the sources. At step 712 the service determines if any of the sources have agreed to meet the customer's demand. If at step 712 there are no takers after a period of time set by the service, then the cycle may end for that customer. One scenario might be that if the customer demand is too stringent and not sound from the perspective of any of the sources then the service may send the customer an alert that no sources could be persuaded to meet the customer's particular demand.

If at step 712 a source agrees to advertise a product or service that meets the customer demand then at step 713 a new electronic ad is requested that meets the customer's stated demands. At step 714 the service reviews and stores the advertisement for service. The process may move loop back to step 708 where the new advertisement is served to the customer toolbar according to the customer configuration data. The process is the same for every registered customer. The service may, using mining of customer data, develop statistics that might be used to sway a source into changing pricing or other parameters for more than one customer. For example, if the service has a large number of customers looking for a particular product and would buy the product if a particular pricing point was reached then a source providing the product might be persuaded to capitalize on the potential number of sales if the price point were met through an advertisement that would be sent to all of those customers having the same preference and pricing point for that product. The source could enforce a one day rule where the product is discounted to match the shared pricing demand of those customers.

In some cases, advertisers will lower pricing to match customer demand for one or more customers if it makes sense to do so. For example, if a product is no longer being carried and the source wants the rest of the inventory liquidated, it may publish that fact to the service, which may in turn search the customer database for customers who want to view ads about that product. It may then suggest to the source a price that will likely result in successful liquidation of the inventory. The source would agree, create the ad offer and send it to the service who in turn would serve the ad into the customer toolbars.

In one embodiment of the present invention, the service is capable of tracking clicks on advertisements that were served to customers, and may in some embodiments be able to track purchases of products and services made by customers using the service. This data may be stored and developed for statistics that may help providers tune in better to customer trends and developments. The statistical information may be provided to source companies for a modest service fee.

The present invention may be practiced over the Internet and any connected sub-networks without departing from the spirit and scope of the present invention. It will be apparent to one with skill in the art that the advertising toolbar system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

1-11. (canceled)

12. A method for brokering advertisements, comprising the steps:
(a) receiving, by an advertising service provider executing software on an Internet-connected server, specific criteria for advertisements from individual users, the criteria including specific products or services, and acceptable pricing for those products or services;
(b) searching on-line advertisement stores for advertisements fitting the criteria;
(c) negotiating with the advertisers to meet criteria of users;
(d) receiving one or more advertisements that meet the user-specified criteria; and
(e) serving the one or more advertisements to one or more user-operated computing appliances according to the users who specified the criteria.

13. The method of claim 12 wherein user-specified criteria is aggregated and prices averaged per the criteria for goods and services available.

14. The method of claim 12 wherein in step (b) advertisement stores include any searchable medium connected to the network.

15. The method of claim 12 wherein in step (c) negotiation includes-price negotiation for goods or services and time period negotiation for honoring negotiated pricing.

16. The method of claim 12 wherein in step (b) a search engine is used to locate and identify advertisements that fit user criteria.

17. The method of claim 12 wherein in step (a) user criteria is published to a pricing server and advertisers make pledges to honor accepted criteria and create or modify existing advertisements to validate the pledge.

18. An advertisement brokering service comprising:
an Internet-connected server executing software, the software providing;
a stored application downloadable by a connected appliance associated with a specific user, to enable the user, through the device, to configure and send to the server advertisement criteria, including specific products or services and acceptable pricing for those products or services, and to receive and display advertisements served by the server; and
a data repository associating specific users with the advertisement criteria configured by the user;
which is associated in the data repository with the user who uploads the criteria, and the server searches on-line data stores for advertisements that match the criteria, negotiates with advertisers to meet user criteria, and serves matching advertisements to the users.

19. The advertisement brokering service of claim 18 wherein the network is the Internet network and the computing appliances are a mix of desktop computers, laptop computers cellular telephones and personal digital assistants.

20. The advertisement brokering system of claim 18 wherein advertisements for desired goods and services are located based on a search of advertisement stores using the criteria of individuals to return available advertisements to those individuals or using average values from the aggregated criteria of multiple users to locate advertisements relative to most popular goods and services at the average pricing range calculated among the users inputs.
